(19) United States
(12) Patent Application Publication
(10) Pub. No.: US 2003/0079216 A1
(43) Pub. Date: Apr. 24, 2003

(54) Apparatus and method of using a hybrid of fixed media data and network-based data to provide software changes

(75) Inventors: Jacqueline Claire Drane, Austin, TX (US); Gerald Francis McBrearty, Round Rock, TX (US); Shawn Patrick Mullen, Buda, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/981,901

(22) Filed: Oct. 18, 2001

(51) Int. Cl. G06F 9/44; G06F 9/445

(52) U.S. Cl. 717/173; 717/178

(57) ABSTRACT

An apparatus and method for downloading software product fixes, updates, enhancements etc. only when absolutely needed and only for temporary use are provided. When the software product begins to execute, a feature uses a web address, embedded in the software product, to access a Web site where changes such as updates, fixes, enhancements etc. are logged in. Each fix or update has a tag or title that corresponds to a tag or title in the product. These tags or titles are downloaded. When information indexed by a tag or title is going to be used, the feature accesses the network to download the information (i.e., the update or fix). This information is used until the user stops execution of the software product.

### BACKGROUND OF THE INVENTION

1. Technical Field:

The present invention is directed to an apparatus and method of fixing, updating or enhancing software products. More specifically, the present invention is directed to an apparatus and method of using a hybrid of fixed media data and Web-based data to provide fixes or updates to software products to the public.

2. Description of Related Art:

With the ever-increasing pace of advancement in computer related technologies, software developers often compete to be the first to offer a new feature or upgrade. As a result, sometimes software products are made available to the public with unknown defects or errors. These defects are often remedied by providing fixes or updates to the software product.

Fixes or updates are presently provided to the public in a variety of methods. One method is to provide the entire updated or corrected software product on a computer readable medium that a user may use to replace the defective product. Another method is to make the fixes or update available on a Web site on the Internet. A user who has access to the Internet may periodically (or when aware of a fix or update) peruse the Web site for fixes or update. If a fix or update is available, the user may download and install the fix or update.

Some software developers, instead of having users (especially those who have a permanent connection to the Internet) peruse a Web site for fixes or updates, equip their software products with a feature that periodically accesses a Web site to determine whether fixes or updates have been made available. If the feature determines that a fix or update is available, the feature may prompt a user as to whether the fix or update is to be downloaded. If the user so indicates, the feature then downloads the fix or update. After having prompted the user and received an affirmative answer that the fix or update is to be installed, the feature installs the fix or update on the user's computer system.

In all the methods outlined above, when a fix or update is installed, the actual original installed software product is permanently changed. There are instances, however, when a user may not want the original installed software product to be permanently changed. For example, suppose a fix or update encompasses hundreds of Megabytes of software code and suppose further that a user may rarely, if at all, have any use for the fix or update, the user may not want that much storage space to be permanently used for the potentially few occasional times the fix or update may be used.

What is needed, therefore, is an apparatus and method of downloading software product fixes or updates only when absolutely needed and to only install them temporarily on a computer system.

### SUMMARY OF THE INVENTION

The present invention provides an apparatus and method of downloading software product fixes, updates, features etc. only when absolutely needed and for temporary use. When the software product begins to execute, a feature uses a web address, embedded in the software product, to access a Web site where changes such as updates, fixes etc. are logged in. Each fix or update has a tag or title that corresponds to a tag or title in the product. These tags or titles are downloaded. When information indexed by a tag or title is going to be used, the feature accesses the network to download the information (i.e., the update or fix). This information is used until the user stops execution of the software product.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a flow diagram of a process used by the present invention.

FIG. 5 is a representation of the manner in which the Web site is organized.

FIG. 6 depicts a representative Web site database of changes.

### DETAILED DESCRIPTION OF THE PREFERRED EMBODIMENT

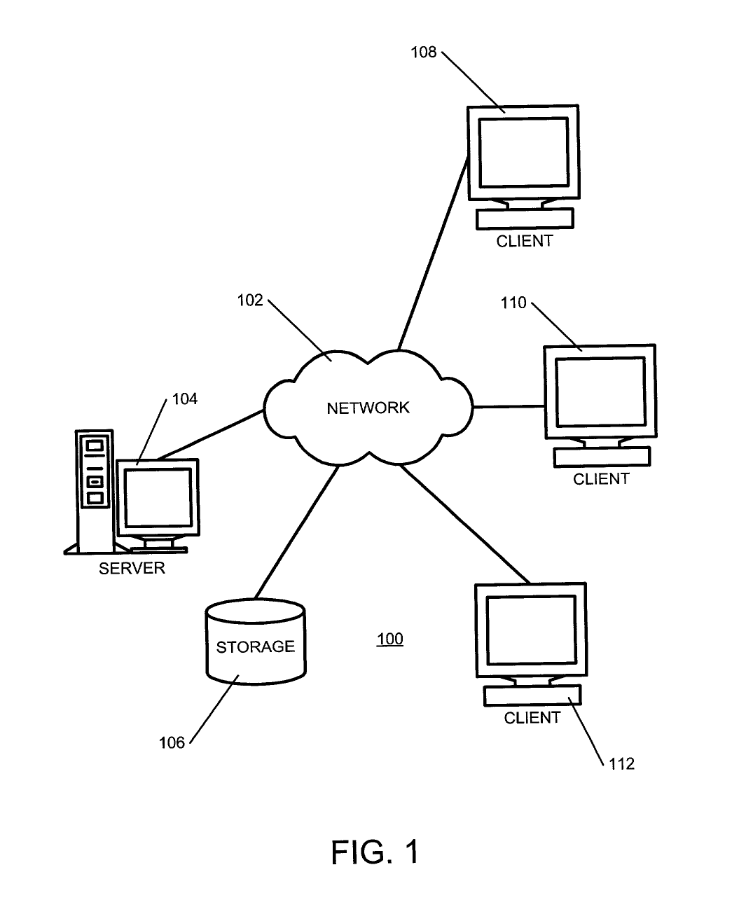

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

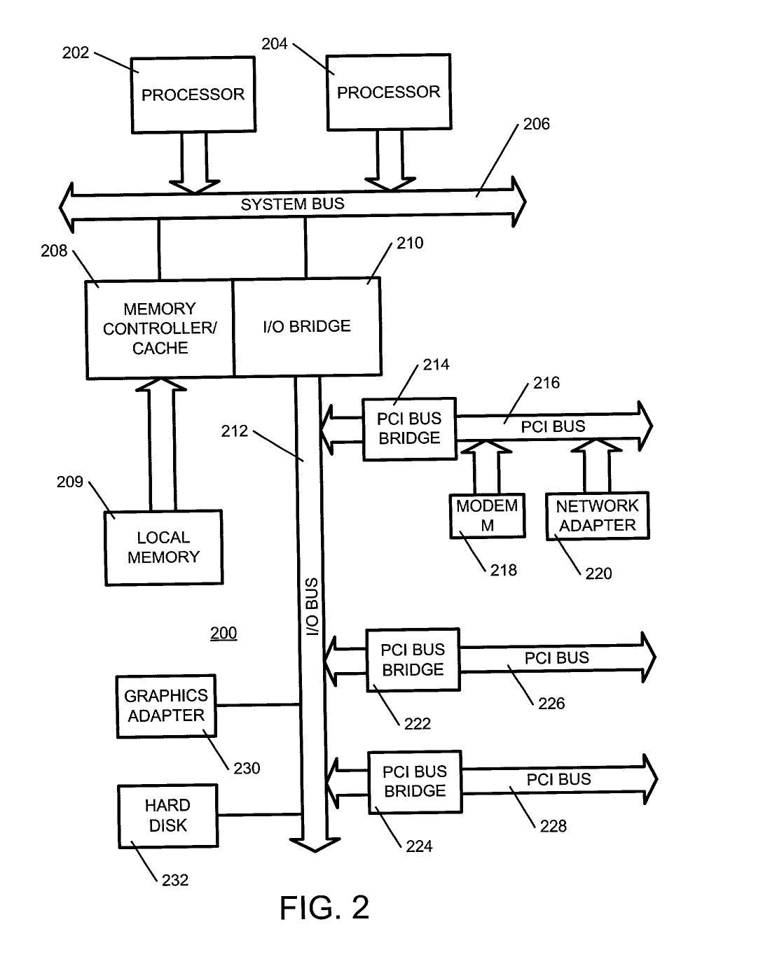

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

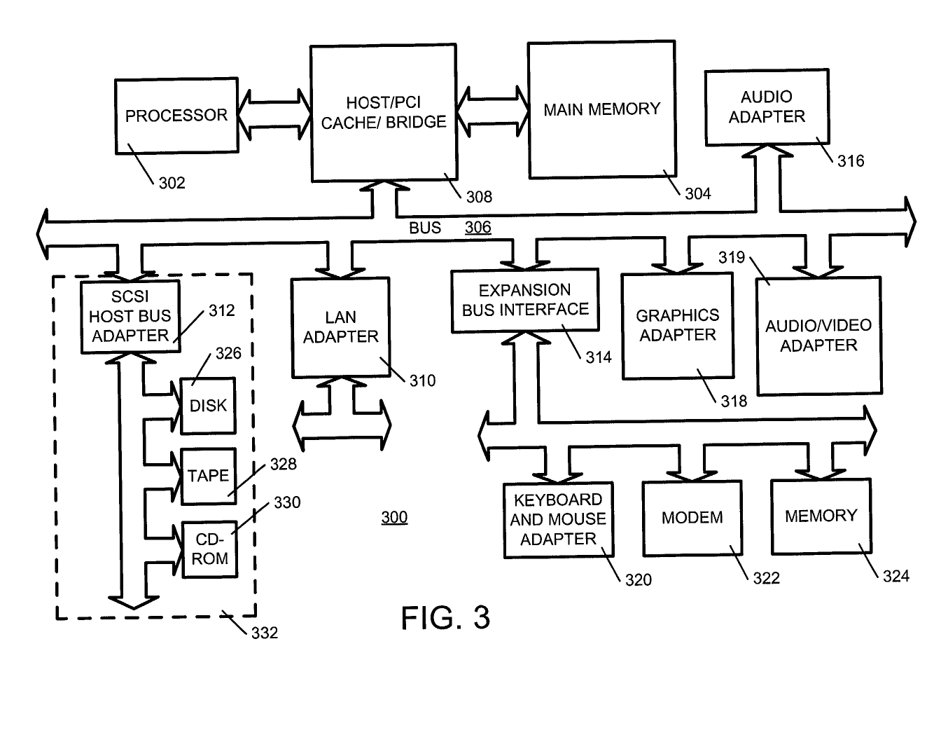

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of downloading a software product fix or update when needed and installing the fix or update only temporarily. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

To better understand the invention, an example will be provided. Suppose a software company develops and sells operating systems. Operating systems are usually sold to the public accompanied with a user's manual. Suppose that the manual is provided on a non-writable medium such as a compact disk (CD). There may be times when the information in the manual does not properly document the product.

For example, it is well known in the field that information documenting software products (i.e., user's manual) is usually processed weeks or months in advance of the release of the software it documents. During the time the information is being processed (i.e., formatted and duplicated on CDs etc.), the actual product it documents may have gone through some more metamorphosis. Thus, when the software product is actually released to the public, the information in the manual may not properly document it.

As mentioned before, fixes or updates may be provided to bring the user's manual up to par with the software product it documents. The present invention uses a feature that accesses a Web site to determine whether there are updates to the software product each time the product is loaded into memory. Unlike one of the present methods where whenever there is an update users are prompted to decide whether to download and install the update, the present invention does not download an update unless the update is actually needed. Furthermore, when an update is downloaded it is done totally transparent to the user and is only installed temporarily.

Returning to the example, user's manuals are usually arranged in sections, sub-sections etc. Thus, fixes and updates will be in one or a few sections or sub-sections etc. of the manual. When a user is using the manual (i.e., when the software product is being executed), a background process does the following: (1) reads a hidden file in the CD file system structure that lists a contact Web address (i.e., URL), (2) accesses the Web site to determine whether there are any fixes or updates, (3) if there are fixes or updates, the process notes in what sections or sub-sections of the manuals the fixes exist.

If while browsing the manual the user wants to access one of the sections or sub-sections of the manual that have been updated, the process will re-access the Web site or may access another Web site if the changes are located on another Web site. After accessing the Web site containing the changes, the process then will download only the section or sub-section that has changed and the user wants to access. Once downloaded, that section or sub-section will be loaded into memory instead of the section or sub-section of the manual that is on the CD. Thus, the present invention provides a seamless update that works in conjunction, but not in place of the fixed media (i.e., the CD in this case).

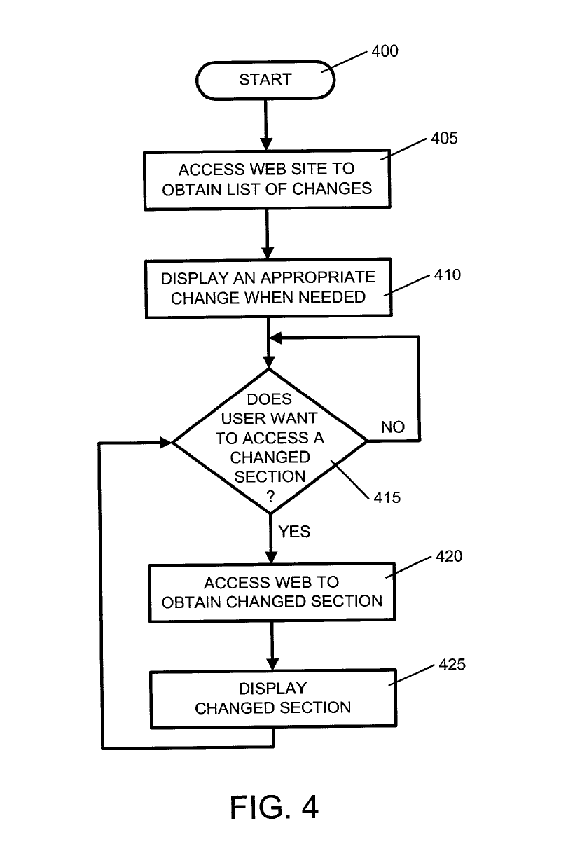

FIG. 4 is a flow diagram of a process used by the present invention. The process starts whenever a software product that has the feature provided by the present invention begins to execute (step 400). As mentioned above, as soon as the process starts, it accesses a Web site to determine whether there are any changes, updates, fixes etc. for the software product (step 405).

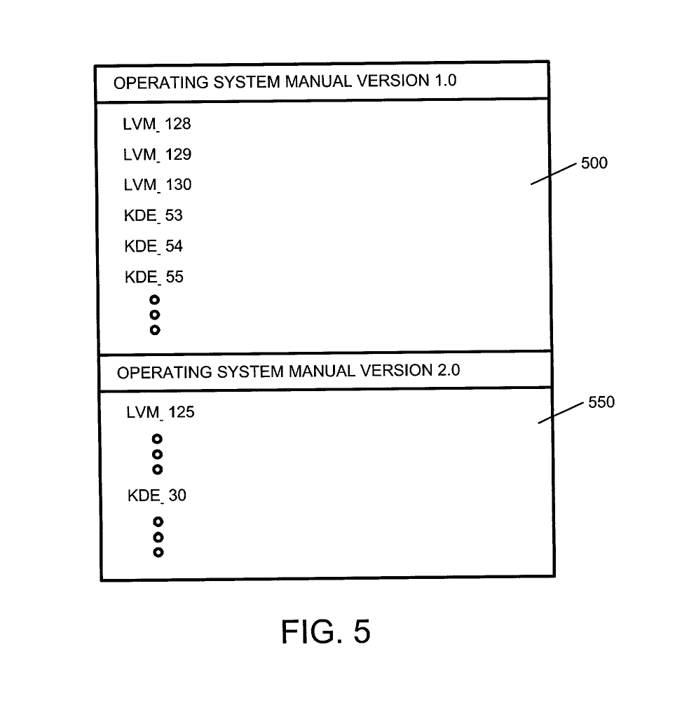

FIG. 5 is a representation of the manner in which the Web site is organized. Obviously, a company may use the Web site for any changes to any software product that there may be. Accordingly, the process needs to have a tag by which to identify where to go to get the changed sections. In this example, the name of the software product as well as the version in use by the user may be used as the tag. Thus, if the software product in use by the user is “Operating System Manual” and its version is “1.0”, then the feature will go to area 500 of the Web site to look for changes. If on the other hand, the software product is “Operating System Manual” version “2.0”, the feature will go to area 550 to look for updates. Any entry found in these areas signifies a change to the respective software product.

As mentioned earlier, the manual is organized in sections and sub-sections etc. Each entry then relates to a section or sub-section of the original software product in use by the user. In this particular example, section titles Lvm_128 to Lvm_130 and Kde_53 to Kde_55 etc. will be downloaded to the user's computer. Note that only the titles of the sections or sub-sections are downloaded and not the actual changes. Accordingly, this download process will be quite short and quick.

Returning to FIG. 4, after the titles are downloaded, the corresponding titles in the software product in use will be replaced by the downloaded titles when and if they are displayed (step 410). If additional titles are provided (e.g., new sections are provided that don't have corresponding sections in the original software product), they will be inserted in their proper space (each downloaded title contains an instruction stating whether it is an added section and where it is to be inserted) . Thus, if the original software product did not have a section called Lvm_130. The downloaded Lvm_130 will nonetheless be inserted in the proper place (i.e., after Lvm_129) as the software product will be so instructed.

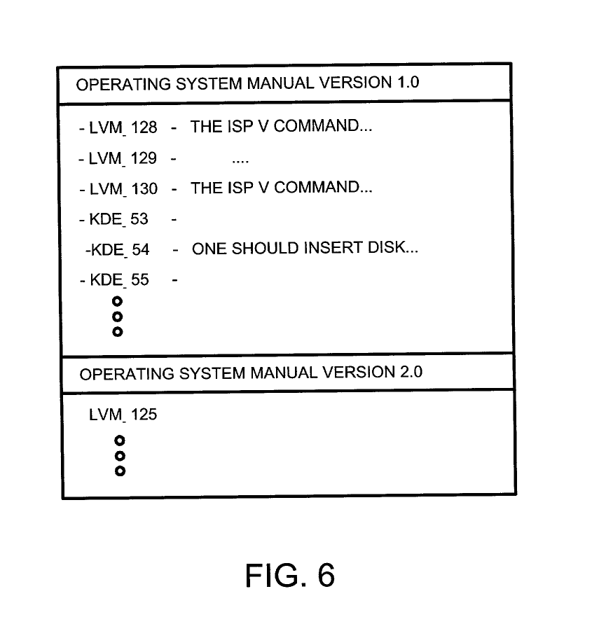

After displaying the downloaded titles, a check will continuously be made to determine whether the user wants to access one of the sections or sub-sections that have changed. When the user scrolls through one of the sections or sub-sections or double-clicks on one of the downloaded titles etc., this signals that the changed section is to be downloaded for display. If so, the process then accesses the Web site where the actual changes are located. In this case, each title may have a URL (i.e., Web address) specifying where the actual change resides on the. FIG. 6 depicts a representative Web site database of changes. Once the change is downloaded, then it is ready to be displayed (steps 415, 420 and 425). When the execution of the software product has terminated, all downloaded titles and sections will cease to exist on the user's computer system.

Note that, some changes may be pre-fetched from the Web site. For example, if a section that references another section containing a change is being displayed, there is a high likelihood that the referenced section may be needed. Hence, the referenced section may be pre-fetched from the Web site. Another example regarding when a changed section is to be pre-fetched is when related sections to a changed section are being accessed. When that occurs, chances are the changed section may be accessed as well. Therefore, the changed section may be pre-fetched. Related sections, in this case, may be sections that cover the same or similar topics.

The invention ensures that some users (i.e. those who have a permanent connection to the Internet) will always use the latest changes or version of a software product. As mentioned before, last minute changes or after-the-fact changes are incorporated into a software product whenever needed and without a user being aware of such changes. The actual software product does not have to be entirely replicated on CDs or on the Web site when changes exist. Only the actual changes need to be present. Consequently, only non-valid information contained in a software product needs to be downloaded from a Web site.

The invention has been described in terms of user's manuals, however, those skilled in the art will readily understand that it is not restricted only to user's manuals. Any software products that are made of modules are perfectly within the scope of the invention. In that case, a module that contains a change since the release of the software product may temporarily replace the original module when needed.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of utilizing a software product, said software product including data on a fixed media, said method comprising the steps of:
utilizing said data on said fixed media; and
utilizing a network-based data while the software product is in use for temporarily replacing outdated or errored data on said fixed media.

2. The method of claim 1 wherein the network-based data is downloaded for use only when said data is about to be utilized.

3. The method of claim 2 further comprising the step of determining whether said software product contains outdated or errored data upon running said software product.

4. The method of claim 3 wherein the determining step includes the step of accessing said network to download tags of said outdated or errored data if there is outdated or errored data.

5. The method of claim 4 wherein when an outdated or errored data is going to be used, a tag corresponding to said data is used to download the network-based data to temporarily replace the outdated or errored data.

6. A computer program product on a medium for utilizing a software product, said software product including data on a fixed media, said computer program product comprising:
code means for utilizing said data on said fixed media; and
code means for utilizing a network-based data while the software product is in use for replacing outdated or errored data.

7. The computer program product of claim 6 wherein the network-based data is downloaded for use only when said data is about to be utilized.

8. The computer program product of claim 7 further comprising code means for determining whether said software product contains outdated or errored data upon running said software product.

9. The computer program product of claim 8 wherein the determining code means includes code means for accessing said network to download tags of said outdated or errored data if there is outdated or errored data.

10. The computer program product of claim 9 wherein when an outdated or errored data is going to be used, a tag corresponding to said data is used to download the network-based data to temporarily replace the outdated or errored data.

11. An apparatus for utilizing a software product, said software product including data on a fixed media, said apparatus comprising:
means for utilizing said data on said fixed media; and
means for utilizing a network-based data while the software product is in use for replacing outdated or errored data.

12. The apparatus of claim 11 wherein the network-based data is downloaded for use only when said data is about to be utilized.

13. The apparatus of claim 12 further comprising means for determining whether said software product contains outdated or errored data upon running said software product.

14. The apparatus of claim 13 wherein the determining means includes means for accessing said network to download tags of said outdated or errored data if there is outdated or errored data.

15. The apparatus of claim 14 wherein when an outdated or errored data is going to be used, a tag corresponding to said data is used to download the network-based data to temporarily replace the outdated or errored data.

16. A computer system for utilizing a software product, said software product including data on a fixed media, said computer system comprising:
a memory device for storing data; and
a processor for processing said stored data, said stored data for utilizing said data on said fixed media and for utilizing a network-based data while the software product is in use for replacing outdated or errored data.

17. The computer system of claim 16 wherein the network-based data is downloaded for use only when said data is about to be utilized.

18. The computer system of claim 17 wherein said stored data for determining whether said software product contains outdated or errored data upon running said software product.

19. The computer system of claim 18 wherein determining whether said software product contains outdated or errored data code means includes accessing said network to download tags of said outdated or errored data if there is outdated or errored data.

20. The computer system of claim 19 wherein when an outdated or errored data is going to be used, a tag corresponding to said data is used to download the network-based data to temporarily replace the outdated or errored data.
